(19) United States
(12) Patent Application Publication
(10) Pub. No.: US 2019/0176887 A1
(43) Pub. Date: Jun. 13, 2019

(54) RECOGNITION DEVICE AND RECOGNITION METHOD

(71) Applicant: DENSO CORPORATION, Kariya-city, Aichi-pref. (JP)

(72) Inventor: Shohei YASUDA, Kariya-city, Aichi-pref. (JP)

(21) Appl. No.: 16/323,870

(22) PCT Filed: Jul. 26, 2017
(86) PCT No.: PCT/JP2017/027125

§ 371 Date: Feb. 7, 2019

(30) Foreign Application Priority Data
Aug. 11, 2016 (JP) 2016-158303

(51) Int. Cl. B62D 15/02; B60W 30/10; B60W 50/14; B60W 30/09; G06T 7/13; G06T 7/70

(52) U.S. Cl. CPC B62D 15/0265; B60W 30/10; B60W 50/14; B60W 30/09; B62D 15/029; B60Q 9/008; G06T 7/70; B60W 2710/20; B60W 2550/10; B60W 2550/20; G06T 7/13

(57) ABSTRACT

A recognition device mounted on a vehicle to recognize a traveling area in which the vehicle travels, the recognition device comprising: an edge detection unit for detecting an edge line that defines one edge of the traveling area in a lateral direction orthogonal to a traveling direction of the vehicle; an object detection unit for detecting a position of a moving object existing in front of the vehicle in the traveling direction; and a correction unit for correcting, when the moving object is positioned between the vehicle and the edge line in the lateral direction, a position in the lateral direction of the edge line detected by the edge detection unit to a position between the vehicle and the moving object, or to a position within a width of the moving object.

### CROSS REFERENCE TO RELATED APPLICATION

The present application is based on JP 2016-158303 A filed on Aug. 11, 2016, the contents of which are incorporated herein by reference.

### TECHNICAL FIELD

The present disclosure relates to a recognition device configured to recognize a traveling area in which a vehicle travels, and a recognition method executed by the recognition device.

### BACKGROUND ART

Conventionally, recognition of the shape of the traveling area in which the vehicle travels is performed by an imaging device, a radar device, or the like. In a vehicle equipped with a device for performing such recognition, when the host vehicle approaches an edge of the recognized traveling area, or when the host vehicle straddles an edge, measures are taken to prevent the host vehicle from deviating from the traveling area; for example, a warning is issued to the driver, or a torque is applied to the steering device to move the vehicle towards the center of the traveling area.

In the case the shape of the traveling area is recognized in such manner and control is performed based on the recognized traveling area, there is a risk that the shape of the recognized traveling area is different from the shape of the actual traveling area due to erroneous recognition of the traveling area. If the control for preventing deviation from the traveling area is performed based on the shape of the erroneously recognized traveling area, there may be unnecessary activation that executes the control to prevent deviation from the traveling area even when the host vehicle has not deviated from the traveling area or the possibility of deviation is low. In addition, inactivation may occur and the control to prevent deviation from the traveling area may not be executed even when the host vehicle has deviated from or is about to deviate from the traveling area.

PTL 1 discloses an example of a recognition device configured to suppress erroneous recognition of the traveling area. In the recognition device disclosed in PTL 1, in order to suppress erroneous recognition of the road shape, correction of the road shape recognized by an imaging device, a radar device, or the like is performed. Specifically, in the recognition device described in PTL 1, in addition to the road shape, the position of a stationary object existing in front of the vehicle in its traveling direction is acquired. The road shape is corrected based on the detected position of the stationary object. By correcting the road shape in such manner, inactivation and unnecessary activation of the control for suppressing deviation from the traveling area are suppressed.

### CITATION LIST

### Patent Literature

[PTL 1] JP 5094658 B

### SUMMARY OF THE INVENTION

Use of the recognition device described in PTL 1 is limited to cases where the road shape can be corrected. For example, there is not always a stationary object at an edge of the traveling area, and when there is no stationary object, correction of the edge of the traveling area may not be possible. In addition, when there is a stationary object located at a distance from an edge of the traveling area, and the edge of the traveling area is corrected based on the position of the stationary object, a difference may be generated between the actual traveling area and the corrected traveling area. In this case, it may be difficult to solve the above-mentioned problem in performing control for suppressing deviation from the traveling area.

The present disclosure has been made to solve the above problems, and its main object is to provide a recognition device capable of appropriately recognizing a traveling area in which a vehicle travels.

A recognition device mounted on a vehicle to recognize a traveling area in which the vehicle travels, the recognition device comprising: an edge detection unit for detecting an edge line that defines one edge of the traveling area in a lateral direction orthogonal to a traveling direction of the vehicle; an object detection unit for detecting a position of a moving object existing in front of the vehicle in the traveling direction; and a correction unit for correcting, when the moving object is positioned between the vehicle and the edge line in the lateral direction, a position in the lateral direction of the edge line detected by the edge detection unit to a position between the vehicle and the moving object, or to a position within a width of the moving object.

When there is a moving object in front of the vehicle in the traveling direction, as viewed in the lateral direction orthogonal to the traveling direction of the vehicle, the area on the vehicle side of the moving object is a range in which the vehicle can pass the moving object or the vehicle and the moving object can pass each other. Further, the position of the moving object itself is a range in which the vehicle can follow the moving object. In other words, it can be said that the area on the vehicle side of the position of the moving object and the position of the moving object are both ranges in which the vehicle can travel. In the above configuration, when an edge line which is one of the edges of the traveling area in which the vehicle travels is detected, the correction unit corrects the position of the edge line to a position between the vehicle and the moving object or to the position of the moving object. Thus, even if there is a gap between the detected edge line and the actual edge line, it is possible to properly define one of the edges of the traveling area in which the vehicle can travel.

### BRIEF DESCRIPTION OF THE DRAWINGS

The above and other objects, features, and advantages of the present disclosure will become clearer from the following detailed description with reference to the accompanying drawings. In the drawings,

FIG. 1 is a configuration diagram of a driving support ECU serving as a recognition device;

FIG. 2 is a diagram for explaining the process in the case where there is no preceding vehicle in the first embodiment;

FIG. 3 is a diagram for explaining the process in the case where there is a preceding vehicle in the first embodiment;

FIG. 4 is a diagram for explaining the process in the case where the road is a curved road in the first embodiment;

FIG. 5 is a flowchart illustrating the process according to the first embodiment;

FIG. 6 is a diagram for explaining the process according to the second embodiment;

FIG. 7 is a diagram for explaining the process according to the third embodiment;

FIG. 8 is a diagram for explaining the process according to the fourth embodiment; and

FIG. 9 is a diagram illustrating another example of the process according to the fourth embodiment.

### DESCRIPTION OF THE EMBODIMENTS

Embodiments will be described below with reference to the drawings. The same or equivalent parts in the embodiments described below are assigned with the same reference number in the drawings, and an earlier explanation should be referred to regarding those parts having the same reference number as another.

### First Embodiment

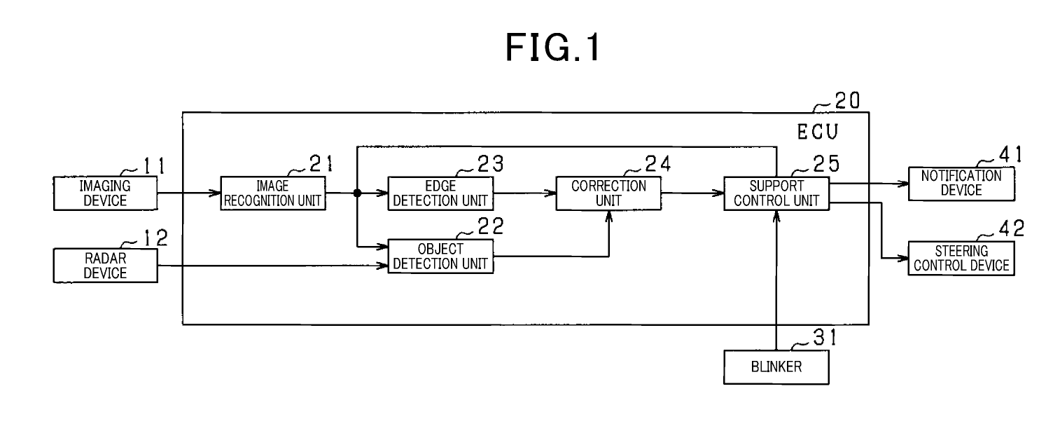

The recognition device according to the present embodiment is mounted on a vehicle (host vehicle) and is configured to recognize the traveling area in which the vehicle travels. First, with reference to FIG. 1, the configuration of a system including a driving support ECU 20 corresponding to a recognition device will be described.

The imaging device 11 is a device including a monocular camera or a stereo camera, such as a CCD image sensor, a CMOS image sensor, or a near infrared sensor. For example, the imaging device 11 is attached near the upper end of the windshield of the host vehicle and around the center in the vehicle width direction, and acquires a bird's-eye-view image of an area spreading in a certain angular range toward the forward direction of the host vehicle. The imaging device 11 transmits the captured image to the driving support ECU 20 at every predetermined period.

The radar device 12 is, for example, a well-known millimeter wave radar using a high-frequency signal in the millimeter wave band as the transmission wave, and it is provided at a front-end part of the host vehicle to detect the position of a target within its detection range which is a range with a certain detection angle in which it can detect the target. Specifically, a probing wave is transmitted at a predetermined cycle, and the reflected wave is received by a plurality of antennas. The distance to the target is calculated from the transmission time of the probing wave and the reception time of the reflected wave. In addition, the relative speed is calculated from the frequency of the reflected wave reflected by the target that has been changed by the Doppler effect. Further, the azimuth of the target is calculated from the phase difference of the reflected waves received by the plurality of antennas. If the position and azimuth of the target can be calculated, it is possible to find the relative position of the target with respect to the host vehicle.

In each cycle, the radar device 12 transmits the probing wave, receives the reflected wave, calculates the reflection position and the relative speed, and transmits the calculated reflection position and relative speed to the driving support ECU 20.

The driving support ECU 20 is a computer having a CPU, a ROM, a RAM, an I/O, and the like. The CPU of the driving support ECU 20 implements each function by executing a program installed in the ROM.

The image recognition unit 21 of the driving support ECU 20 extracts feature points indicating a moving object, a road structure, a lane marking, etc. existing around the host vehicle from the image acquired by the imaging device 11. Specifically, edge points are extracted based on the luminance information of the image acquired by the imaging device, and the Hough transform is performed on the extracted edge points. In the Hough transform, for example, points on a straight line on which a plurality of edge points are arranged consecutively, and points at which straight lines cross orthogonality with each other are extracted as feature points.

The object detection unit 22 performs pattern matching on a feature point group including a plurality of feature points acquired from the image recognition unit 21 with a prestored pattern of a feature point group, and extracts an object corresponding to the feature point group. In addition, the reflection position acquired from the radar device 12 is converted into coordinates within the image acquired from the imaging device 11, and the reflection position and the relative speed acquired from the radar device 12 are associated with the object in the image. At this time, as described above, the information acquired from the radar device 12 includes not only the reflection position but also the relative speed with respect to the host vehicle. Thus, it is determined whether the object extracted from the image by the image recognition unit 21 is moving in the same direction as the host vehicle or in a direction opposite to that of the host vehicle. That is, if the object is a vehicle and is traveling in the same direction as the host vehicle, it can be regarded as a preceding vehicle or a vehicle traveling in parallel, and if the object is a vehicle and is traveling in the direction opposite to that of the host vehicle, then, it can be regarded as an oncoming vehicle.

The edge detection unit 23 of the driving support ECU 20 extracts, among the feature point groups of the image acquired from the image recognition unit 21, a feature point group extending away from the vehicle along the traveling direction of the own vehicle, and regards the feature point group as an edge line indicating an edge of the road on which the host vehicle is traveling. This edge line is obtained based on, for example, a lane marking drawn to separate a roadway from a sidewalk, a curbstone provided at an edge of the road, a guardrail, and the like.

The correction unit 24 corrects the edge line of the traveling area acquired from the edge detection unit 23 based on the position of a moving object detected by the object detection unit 22. The processing executed by the correction unit 24 will be described later.

When the host vehicle is likely to deviate from the traveling area and when the vehicle deviates from the traveling area, the support control unit 25 transmits a control command to at least one of the notifying device 41 and the steering control device 42. Specifically, based on the center of the image acquired from the image recognition unit 21, it is determined whether or not the host vehicle has crossed the edge line. In addition, based on the relative angle of the edge line with respect to the center line of the image, it is determined whether there is a possibility of crossing the edge line if the host vehicle keeps on traveling straight.

To perform these decisions, the support control unit 25 acquires a control signal from the blinker 31. If a control signal is acquired from the winker 31, even if the vehicle is likely to deviate from the traveling area or the vehicle deviates from the traveling area, a control command is not sent to the notifying device 41 and the steering control device 42. This is to respect the intention of the driver to change lanes or the like.

The notifying device 41 is a speaker, a display, or a buzzer installed in the host vehicle. Upon receiving a control command from the driving support ECU 20, the notifying device 41 outputs an alert indicating that the vehicle has deviated from the road or an alert indicating that there is the vehicle may deviate from the road.

The steering control device 42 is a device that executes the steering control of the host vehicle so that the host vehicle keeps traveling inside the track based on the control command transmitted from the driving support ECU 20. Upon receipt of the control command from the support control unit 25, the steering control device 42 performs the steering control so that the host vehicle moves away from the edge of the traveling area and towards the center of the traveling area. It should be noted that the steering control device 42 may perform a control that applies a torque to the steering wheel of the host vehicle in an amount that does not affect the change in the traveling direction in order to inform the driver of the possibility of the host vehicle deviating from the track.

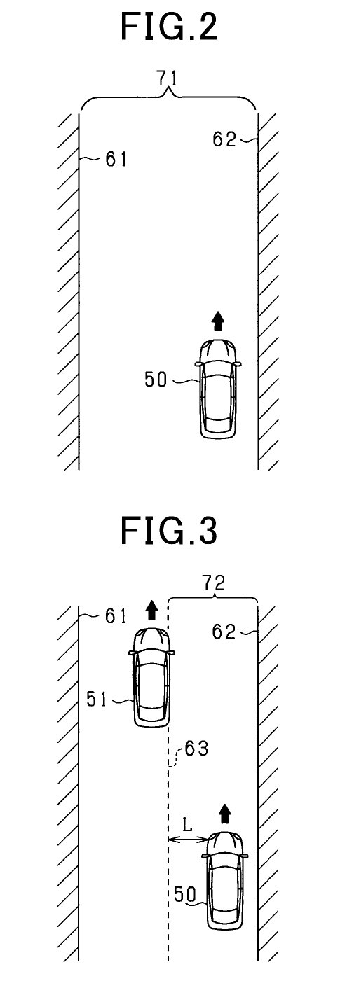

Next, the processing executed by the correction unit 24 will be described with reference to FIGS. 2 and 3. As shown in FIGS. 2 and 3, it is assumed that the host vehicle 50 is traveling toward the upper side of the figures. In the following description, the direction orthogonal to the traveling direction of the host vehicle 50 is defined as “lateral direction”, and the distance from a lateral edge of the vehicle 50 in the lateral direction is defined as “lateral distance L”.

As shown in FIG. 2, when there is no other vehicle which is a moving object within a predetermined distance ahead of the host vehicle 50 in the traveling direction, the range between the left edge 61 of the road and the right edge 62 thereof, which are the edge lines detected by the edge detecting unit 23, is set as the traveling area 71. Therefore, when it is detected that the host vehicle 50 is approaching an edge of the traveling area 71, that is, one of the left edge 61 and the right edge 62 of the road, the support control unit 25 transmits a control command to the notification unit 41 and the steering control unit 42.

In FIG. 3, it is assumed that the other vehicle is a preceding vehicle 51 traveling in the same direction as the host vehicle 50, that is, toward the upper side in the figure. Regarding their relationship in the lateral direction, the preceding vehicle 51 is traveling closer to the left edge 61 of the road than the host vehicle 50 is, and there is a gap between the vehicle 51 and the host vehicle 50. That is, regarding the lateral direction, it is assumed that the preceding vehicle 51 exists between the host vehicle 50 and the left edge 61 of the road.

When the vehicle 50 continues traveling and the preceding vehicle 51 gets closer than the predetermined distance ahead of the host vehicle 50 in the traveling direction as shown in FIG. 3, the object detecting unit 22 inputs the position of the edge of the detected preceding vehicle 51 that is closer to the host vehicle 50 to the correction unit 24. The correction unit 24 determines the lateral distance L between the edge of the preceding vehicle 51 closer to the host vehicle 50 and the edge of the host vehicle 50 closer to the preceding vehicle 51. Then, the correction unit 24 moves the left edge 61 of the road which is the edge line detected by the edge detecting unit 23 to the right in parallel, and sets a corrected line 63 on the left side of the left edge 61 of the host vehicle 50 with a gap of the lateral distance L. That is, the relative angle between the traveling direction of the host vehicle 50 and the corrected line 63 is equal to the relative angle between the traveling direction of the host vehicle 50 and the left edge 61. Since the correction unit 24 sets the corrected line 63 in such manner, the traveling area 72 of the host vehicle 50 becomes the range between the right edge 62 of the road and the corrected line 63.

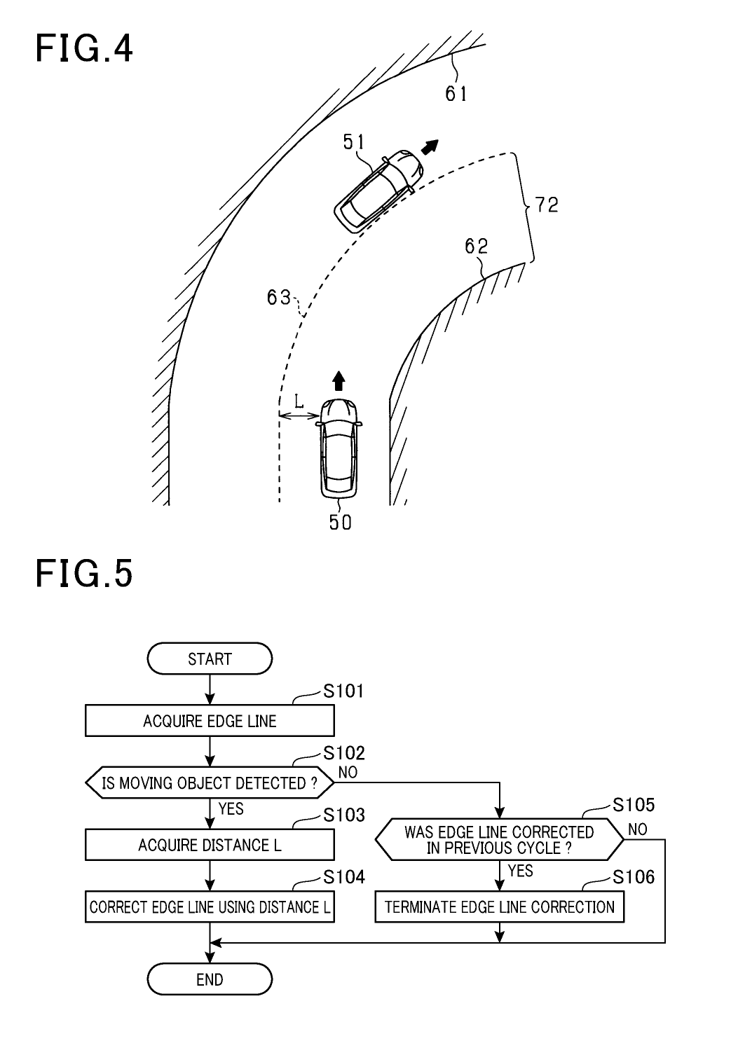

Although FIG. 3 shows an example in which the road is straight and the traveling area 71 defined by the left edge 61 and the right edge 62 of the road is straight, the road may be curved. Correction of the edge line when the road is curved will be described with reference to FIG. 4.

The position of the preceding vehicle 51 is temporarily stored in the memory of the driving support ECU 20 for a certain period of time, for example, until the host vehicle 50 reaches a previous position of the preceding vehicle 51 in the traveling direction. The correction unit 24 reads the lateral position of the preceding vehicle 51 at the time when the position of the preceding vehicle 51 in the traveling direction was the same as the position of the host vehicle 50 in the traveling direction. The correction unit 24 determines a lateral distance L which is the difference between the lateral position that has been read out, that is, the previous lateral position of the preceding vehicle 51 and the current lateral position of the host vehicle 50. Then, the correction unit 24 moves the left edge 61 of the road which is the edge line detected by the edge detecting unit 23 to the right in parallel, and sets a corrected line 63 on the left side of the left edge 61 of the host vehicle 50 with a gap of the lateral distance L.

It is also possible to predict the course of the host vehicle 50 based on the detected left edge 61 or the position of the preceding vehicle 51, and determine the lateral distance L between the edge of the host vehicle 50 closer to the preceding vehicle 51 and the edge of the preceding vehicle 51 closer to the host vehicle 50 based on the predicted course.

The correction process of the edge line performed as described above will be described with reference to the flowchart of FIG. 5. The process shown in FIG. 5 is executed repeatedly at predetermined control intervals.

First, the edge line is acquired in step S101, and in the following step S102, it is determined whether or not a moving object is detected. If the result is affirmative in step S102, that is, if a moving object has been detected, the process proceeds to step S103. In step S103, the lateral distance L between the edge of the vehicle 50 in the moving object side and the edge of the moving object in the host vehicle 50 side is determined. Then, the process proceeds to step S104, and the position of the edge line is changed to a position at the distance of the lateral distance L from the host vehicle 50 using the lateral distance L obtained in step S103, and the shifted line is set as the corrected line 63. After that, the process is terminated.

On the other hand, if the result is negative in step S102, that is, if a moving object is not detected, the process proceeds to step S105, where it is determined whether or not the edge line has been corrected in the previous cycle. If the result is affirmative in step S105, that is, if the edge line has been corrected in the previous control cycle, the process proceeds to step S106, where the correction of the edge line is terminated. Therefore, the traveling area is partitioned by the edge line instead of the corrected line 63. After that, the process is terminated.

On the other hand, when the result is negative in step S105, that is, when the edge line correction is not performed in the previous cycle, the process is terminated as it is. Therefore, the process of defining the traveling area by the edge line instead of the corrected line 63 is continued.

Note that, since the edge line is corrected when a moving object is detected, in step S105, instead of determining whether or not the edge line has been corrected in the previous cycle, it is also possible to determine whether or not a moving object has been detected in the previous cycle.

In this embodiment, it is assumed that the edge line is acquired in step S101. However, when the edge line cannot be acquired, the process of determining whether or not the host vehicle deviates from the traveling area may not be performed.

According to the above configuration, the driving support ECU 10 according to the present embodiment provides the following effects.

When there is a preceding vehicle 51 which is a moving object ahead of the host vehicle 50 in the traveling direction, the area on the side of the preceding vehicle 51 that is closer to the host vehicle 50 in the lateral direction, which is a direction orthogonal to the traveling direction of the host vehicle 50, is a range which the host vehicle 50 can use to pass the preceding vehicle 51. That is, it can be said that the area on the side of the preceding vehicle 51 that is closer to the host vehicle 50 is a range in which the own vehicle 50 can travel. In this embodiment, when the left edge 61 which is one edge of the road on which the host vehicle 50 travels is detected, the position of the left edge 61 is corrected to a position between the host vehicle 50 and the preceding vehicle 51 by the correction unit 24, and the shifted line is set as the corrected line 63. Thus, even if there is a gap between the detected left edge 61 and the actual left edge 61, it is possible to properly define one of the edges of the traveling area 71 in which the vehicle can travel.

When it changes from the state where the object detection unit 22 is detecting the preceding vehicle 51 as the moving object to the state in which it is not detected, the process for correcting the position of the left edge 61 to the corrected line 63 is terminated. Thus, there is no period during which the position of the edge of the traveling area 72 defined by the left edge 61 or the correction line 63 is undetermined, and therefore it is possible to stably perform the control for suppressing deviation from the traveling area 72.

When correcting the left edge 61 to the corrected line 63 by the correction unit 24, if the shape of the corrected line 63 is different from the shape of the actual left edge 61, the accuracy of the control for suppressing deviation from the traveling area may deteriorate. In this regard, in this embodiment, upon correction of the left edge 61 to the corrected line 63, the left edge 61 is moved in parallel to a position between the host vehicle 50 and the preceding vehicle 51 to form the corrected line 63. Thus, the shape of the corrected line 63 conforms to the shape of the actual road. Therefore, the control for suppressing deviation from the traveling area can be appropriately performed, particularly in a curved section of the road.

### Second Embodiment

In the first embodiment, a case where there is a gap between the edge of the host vehicle 50 and the edge of the preceding vehicle 51 in the lateral direction has been described. There may also be a case where the position of the host vehicle 50 and the position of the preceding vehicle 51 partially overlap with each other in the lateral direction. In the present embodiment, a process for the case where the lateral positions of the host vehicle 50 and the preceding vehicle 51 partially overlap is added.

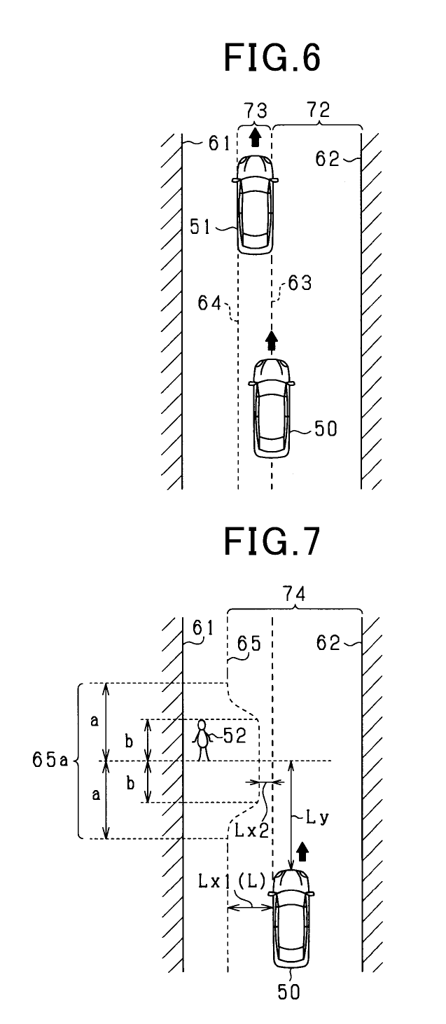

As shown in FIG. 6, when the lateral positions of the host vehicle 50 and the preceding vehicle 51 partially overlap, a straight line or a curved line passing through the edge of the preceding vehicle 51 that is closer to the host vehicle 50 is set as a first corrected line 63. The first corrected line 63 is equivalent to the corrected line 63 in the first embodiment.

In addition, a straight line or a curved line passing through the edge of the preceding vehicle 51 that is opposite to its edge closer to the host vehicle 50, that is, the edge of the preceding vehicle 51 that is closer to the left edge 61 is set as a second corrected line 64.

Since the first corrected line 63 and the second corrected line 64 are thus set, a following range 73 which is the area sandwiched between the first corrected line 63 and the second corrected line 64 is set. When the position of the host vehicle 50 moves from the first corrected line 63 to the traveling area 72, then, the control to suppress deviation from the traveling area 72 is performed as in the first embodiment.

On the other hand, when the position of the host vehicle 50 moves from the first correction line 63 to the following range 73, the driving support ECU performs a control for keeping the distance to the preceding vehicle 51 constant.

According to the above configuration, the driving support ECU 10 according to the present embodiment provides the following effects in addition to the effects of the driving support ECU 10 according to the first embodiment.

In the present embodiment, the first corrected line 63 provided on the side of the preceding vehicle 51 closer to the host vehicle 50 and the second corrected line 64 provided on the side of the preceding vehicle 51 closer to the left edge 61 are set. In this case, it can be said that the range between the first corrected line 63 and the second corrected line 64 is a range in which the host vehicle 50 should follow the preceding vehicle 51. In addition, it can be said that the area on the side of the first corrected line 63 that is closer to the right edge 62 is a range which the host vehicle can use to pass the preceding vehicle 51. Therefore, by setting the first corrected line 63 and the second corrected line 64 as in the present embodiment, it is possible to adequately define the range in which the host vehicle 50 can travel.

### Third Embodiment

In the present embodiment, some control is added to the control executed by the driving support ECU 10 according to the first embodiment. Specifically, a part of the process of setting the corrected line is changed for the case where the moving object is a person.

The correction process of the edge line executed by the driving support ECU 20 according to the present embodiment will be described with reference to FIG. 7. When the object detection unit 22 of the driving support ECU 20 detects a pedestrian 52 as the moving object, the correcting unit 24 obtains a first distance Lx1 which is the distance in the lateral direction between the host vehicle and the pedestrian 52. This first distance Lx1 is equivalent to the lateral distance L in the first embodiment, and is obtained based on the difference in the lateral positions of the host vehicle 50 and the pedestrian 52. Since the lateral width of the pedestrian 52 is smaller than that of a vehicle, the lateral position of the pedestrian 52 may be set at the center of the pedestrian 52, or similarly to the first embodiment, it may be set at the edge of the pedestrian 52 that is closer to the host vehicle 50.

In addition, the correction unit 24 obtains the longitudinal distance Ly which is the distance between the host vehicle 50 and the pedestrian 52 in the traveling direction of the host vehicle 50. This longitudinal distance Ly is obtained as the difference between the edge of the host vehicle 50 on the traveling direction side and the position of the pedestrian 52.

The correction unit 24 sets the corrected line 65 using the first distance Lx1 and the longitudinal distance Ly thus obtained. The corrected line 65 is obtained by moving the left edge 61 of the road parallel to a position at the distance of the first distance Lx1 from the edge of the pedestrian 52 that is closer to the host vehicle 50, and in a certain range 65a near the position of the pedestrian 52, the line protrudes toward the host vehicle 50. More specifically, regarding the range extending for a distance b in each longitudinal direction from a position at a distance of the longitudinal distance Ly from the host vehicle 50, the corrected line 65 is set at a distance of a second distance Lx2 from the host vehicle 50. The second distance Lx2 is set to a value smaller than the first distance Lx1 by a predetermined value (for example, 1 m).

The distance to the host vehicle 50 in the certain range 65a is maintained at the second distance Lx2 until the distance b is secured from the center in the longitudinal direction; the distance gradually increases from the position at the distance b from the center to the position at the distance a; and the distance is maintained at the first distance Lx1 in the zone further than the distance b from the center.

Since the corrected line 65 is set so as to protrude toward the host vehicle 50 side in the certain range 65a as described above, the traveling area 74 of the host vehicle 50 defined by the right edge 62 of the road and the corrected line 65 is narrowed in the vicinity of the pedestrian 52.

Note that, although in the above example the second distance Lx2 and the longitudinal length of the certain range 65a are predetermined values, they may be values that vary according to the first distance Lx1 and/or the longitudinal distance Ly, or they may vary in accordance with the speed of the host vehicle 50.

In addition, although the certain range 65a has a shape that is longitudinally symmetric about the position of the pedestrian 52, it may have a different shape. For example, in the zone beyond the position of the pedestrian 52, the lateral distance between the corrected line 65 and the vehicle 50 may be set to the first distance Lx1. This is because if the host vehicle 50 moves beyond the position of the pedestrian 52, the possibility of contact between the host vehicle 50 and the pedestrian 52 is reduced.

In the case of detecting the pedestrian 52 as a moving object as in this embodiment, the lateral positions of the host vehicle 50 and the pedestrian 52 may also overlap as in the second embodiment. In this case as well, the first distance Lx1 is obtained. In this case, the first distance Lx1 has a negative value. The corrected line 65 is set based on the value of Lx1. That is, once the corrected line 65 is set, the host vehicle 50 is positioned on the corrected line 65. Therefore, when the correction line 65 is set in a case where the lateral positions of the host vehicle 50 and the pedestrian 52 overlap with each other, the conditions for activation of the notification device 41 and the steering control device 42 are satisfied in response to the setting, and the notification device 41 and the steering control device 42 are activated.

According to the above configuration, the driving support ECU according to the present embodiment provides the following effects in addition to the effects of the driving support ECU according to the first embodiment.

When a pedestrian 52 is detected as the moving object, the corrected line 65 in the certain range 65a is protruded toward the host vehicle 50. Therefore, in the control for preventing deviation from the traveling area, it is possible to secure a distance between the pedestrian 52 and the traveling area of the host vehicle 50. Thus, when the host vehicle 50 passes by the pedestrian 52, the control for preventing deviation from the traveling area can be performed securing a sufficient distance from the pedestrian 52, and therefore it is possible to achieve driving that takes into consideration the pedestrian 52.

### Fourth Embodiment

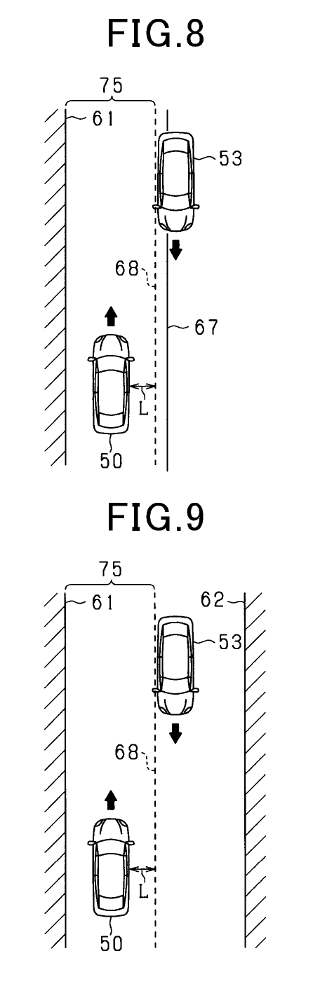

In the present embodiment, an oncoming vehicle 53 is adopted as the moving object for the setting process of the corrected line by the correction unit 24. The process executed by the driving support ECU 20 in the present embodiment will be described with reference to FIG. 8. It is to be noted that FIG. 8 shows an example of the process in a country that adopts left-hand traffic.

The edge detection unit 23 detects a center line 67 as the edge line based on the feature points in the image acquired from the image recognition unit 21. The center line 67 can also be regarded as the right edge of the lane on which the host vehicle 50 is traveling. At this time, when the object detected by the object detection unit 22 is the oncoming vehicle 53, the correction unit 24 corrects the center line 67 based on the position of the edge of the oncoming vehicle 53 that is closer to the host vehicle 50. More specifically, the lateral distance L between the position of the edge of the host vehicle 50 closer to the oncoming vehicle 53 and the position of the edge of the oncoming vehicle 53 closer to the host vehicle 50 is obtained, and the position of the center line 67 is corrected to a position at a distance of the lateral distance L from the edge of the host vehicle 50 closer to the oncoming vehicle 53, thereby obtaining the corrected line 68.

In the present embodiment, a case where the center line 67 which is a lane marking is drawn on the road is shown, but it is also applicable to the case where a lane marking is not drawn. The process for such case will be described with reference to FIG. 9.

Similarly to the first embodiment, the edge detection unit 23 detects the left edge 61 and the right edge 62 of the road as the edge lines. At this time, if the object detecting unit 22 detects an oncoming vehicle 53, the correction unit 24 obtains the lateral distance L between the edge of the host vehicle 50 that is closer to the oncoming vehicle 53, that is, the right edge 62 corresponding an edge line, and the edge of the oncoming vehicle 53 that is closer to the host vehicle 50. Then, the correction unit 24 corrects the position of the right edge 62 of the road to a position at a distance of the lateral distance L from the host vehicle 50 using the obtained lateral distance L, and sets it as the corrected line 68.

Since the control performed by the support control unit 25 to suppress deviation from the traveling area using the corrected line 68 set in FIG. 8 or 9 is the same as in the first embodiment, its specific explanation will be omitted.

According to the above configuration, the driving support ECU 20 according to the present embodiment provides the following effects in addition to the effects of the driving support ECU 20 according to the first embodiment.

When there is an oncoming vehicle 53 which is a moving object ahead of the host vehicle 50 in the traveling direction, the area on the side of the oncoming vehicle 53 that is closer to the host vehicle 50 in the lateral direction, which is the direction orthogonal to the traveling direction of the host vehicle 50, is a range in which the host vehicle 50 and the oncoming vehicle 53 can pass each other. That is, it can be said that the area on the side of the oncoming vehicle 53 that is closer to the host vehicle 50 is a range in which the own vehicle 50 can travel. In this embodiment, when the center line 67 or the right edge 62 of the road on which the host vehicle 50 travels is detected, the corrected line 68 is set between the host vehicle 50 and the oncoming vehicle 53 by the correction unit 24. Thus, even if there is a gap between the detected centerline 67 or right edge 62 and the actual position thereof, it is possible to properly define one of the edges of the traveling area 75 in which the vehicle can travel.

### <Variations>

In the first embodiment, when the detection of the moving object is no longer performed, the edge of the traveling area is immediately switched from the corrected line to the edge line. Regarding this, it is also possible to gradually shift from the corrected line to the edge line when the detection of the moving object stops. Further, since the detection of the moving object may be temporarily interrupted, for example, for one to several control cycles, the road edge may be switched from the corrected line to the edge line when the detection of the moving object is not performed for a predetermined period, for example, several control cycles.

In the above embodiments, the lateral distance L between the edge of the host vehicle 50 closer to the edge of the road and the edge of the moving object closer to the host vehicle is obtained, and the corrected line is set at the distance of the distance L from the edge of the host vehicle 50 closer to the edge of the road. The corrected line may also be set to be located between the host vehicle 50 and the moving object.

In the above embodiments, the edge line indicating an edge of the road is acquired based on the image acquired by the imaging device 11. Alternatively, a radar device 12 may detect the step of a road shoulder at an edge of the road, a guardrail provided at an edge of the road, or the like, and the edge line may be acquired based on the position of the step of the road shoulder, the guardrail, or the like.

In the second embodiment, only one of the first corrected line 63 and the second corrected line 64 may be obtained. In the case only the first corrected line 63 is obtained, a process similar to that of the first embodiment is performed. In the case the second corrected line 64 is obtained, the traveling area whose left edge is defined by the second corrected line 64 is a traveling area in which the preceding vehicle 51 is already traveling. Therefore, it can be said that, even if the traveling area is defined by the second corrected line 64 and the right edge 62, the host vehicle 50 can travel in the traveling area.

In the above embodiments, examples of the process are shown to be performed in a country that adopts left-hand traffic. However, the same process can be performed in countries that adopt right-hand traffic by reversing left and right.

In the above embodiments, the driver is supported using the corrected line. However, the technique is also applicable to a system in which the ECU automatically performs a part or all of the driving operation.

Although the present disclosure is described based on examples, it should be understood that the present disclosure is not limited to the examples and structures. The present disclosure encompasses various modifications and variations within the scope of equivalence. In addition, the scope of the present disclosure and the spirit include other combinations and embodiments, only one component thereof, and other combinations and embodiments that are more than that or less than that.

1.-8. (canceled)

9. A recognition device mounted on a vehicle to recognize a traveling area in which the vehicle travels, the recognition device comprising:
an edge detection unit for detecting an edge line that defines one edge of the traveling area in a lateral direction orthogonal to a traveling direction of the vehicle;
an object detection unit for detecting a position of a moving object existing in front of the vehicle in the traveling direction; and
a correction unit for correcting, when the moving object is positioned between the vehicle and the edge line in the lateral direction, a position in the lateral direction of the edge line detected by the edge detection unit to a position between the vehicle and the moving object, or to a position within a width of the moving object.

10. The recognition device according to claim 9, wherein
the correction unit corrects the detected edge line by translating the detected edge line toward the vehicle.

11. The recognition device according to claim 9, wherein
the object detection unit detects another vehicle as the moving object, and
when the other vehicle is positioned closer to the edge line than the vehicle is in the lateral direction and a width of the vehicle and a width of the other vehicle partially overlap with each other, the correction unit corrects the position of the edge line in the lateral direction to a position passing through an edge of the other vehicle that is closer to the vehicle.

12. A recognition device mounted on a vehicle to recognize a traveling area in which the vehicle travels, the recognition device comprising:
an edge detection unit for detecting an edge line that defines one edge of the traveling area in a lateral direction orthogonal to a traveling direction of the vehicle;
an object detection unit for detecting a position of a moving object existing in front of the vehicle in the traveling direction; and
a correction unit for correcting, when the moving object is positioned between the vehicle and the edge line in the lateral direction, a position in the lateral direction of the edge line detected by the edge detection unit to a position within a width of the moving object, wherein
the object detection unit detects another vehicle as the moving object, and
when the other vehicle is positioned closer to the edge line than the vehicle is in the lateral direction and a width of the vehicle and a width of the other vehicle partially overlap with each other, the correction unit corrects the position of the edge line in the lateral direction to a position passing through an edge on the side opposite to the edge on the vehicle side of the other vehicle.

13. The recognition device according to claim 9, wherein
the object detection unit detects a pedestrian as the moving object, and
the correction unit further causes the corrected edge line to protrude toward the vehicle in a certain range including a position of the pedestrian.

14. The recognition device according to claim 9, wherein
the correction unit ends the correction of the edge line when the state changes from a state where the object detection unit is detecting the moving object to a state where it is not detecting the moving object.

15. The recognition device according to claim 9, wherein
the vehicle is provided with a notification device for notifying a driver of the vehicle and a steering control device for performing steering control of the vehicle, and
the vehicle further comprises a support control unit for performing control to prevent deviation from the traveling area using at least one of the steering control device and the notification device in at least one of a case where the vehicle may deviate outside the traveling area and a case where the vehicle has deviated outside the traveling area.

16. A recognition method executed by a recognition device mounted on a vehicle to recognize a traveling area in which the vehicle travels, the method comprising:
an edge detection step for detecting an edge line that defines one edge of the traveling area in a lateral direction orthogonal to a traveling direction of the vehicle;
an object detection step for detecting a position of a moving object existing in front of the vehicle in the traveling direction; and
a correction step for correcting, when the moving object is positioned between the vehicle and the edge line in the lateral direction, a position in the lateral direction of the edge line detected in the edge detection step to a position between the vehicle and the moving object, or to a position within a width of the moving object.
